(19) United States
(12) Patent Application Publication
(10) Pub. No.: US 2007/0206132 A1
(43) Pub. Date: Sep. 6, 2007

(54) TWISTED NEMATIC LIQUID CRYSTAL DISPLAY DEVICES

(75) Inventors: Shih-Min Chao, Kaohsiung City (TW); Tean-Sen Jen, Taoyuan Hsien (TW); Wei-Chi Lin, Hsinchu County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: HANNSTAR DISPLAY CORP., Tao-Yuan Hsien (TW)

(21) Appl. No.: 11/456,582

(22) Filed: Jul. 11, 2006

(30) Foreign Application Priority Data
Mar. 2, 2006 (TW) 95107126

(51) Int. Cl. G02F 1/1335

(52) U.S. Cl. 349/96

(57) ABSTRACT

A liquid crystal display device comprising an upper substrate, a lower substrate, and a liquid crystal layer filled between the upper substrate and the lower substrate. A color filter layer and a first alignment layer are disposed on an inner surface of the upper substrate and adjacent to the liquid crystal. An array of transistors and a second alignment layer are disposed on an inner surface of the lower substrate and adjacent to the liquid crystal. An upper polarizer and a lower polarizer are respectively disposed on both sides the liquid crystal display panel, wherein the upper polarizer is disposed on an outer side of the upper substrate and the lower polarizer is disposed on an outer surface of the lower substrate, and wherein the upper polarizer comprises a plurality of microparticles. The first alignment layer provides a first orientation and the second alignment layer provides a second orientation. The first and the second orientations are substantially perpendicular to each other and substantially parallel to lateral sides of the liquid crystal display panel.

### BACKGROUND OF THE INVENTION

1. Field of the Invention

The invention relates to liquid crystal display (LCD) devices, and in particular to twisted nematic LCD devices with alignment different from 45° and an inner diffusive film therein.

2. Description of the Related Art

FIG. 1 is a cross section of a conventional twisted nematic liquid crystal display (TN LCD). A liquid crystal display 100 comprises an upper substrate 101, a lower substrate 102, and a liquid crystal layer 103 interposed between the upper substrate 101 and the lower substrate 102, serving as an LCD panel. The upper substrate 101 comprises a color filter 104, a common electrode 105, and a first alignment layer 106 thereon. The lower substrate 102 comprises a thin film transistor (TFT) array (not shown), a pixel electrode 107, and a second alignment layer 108 thereon. The liquid crystal display 100 further comprises an upper polarizer 109 and a lower polarizer 110 respectively disposed on both sides of the LCD panel. The upper polarizer 109 is adjacent to the upper substrate 101 while the lower polarizer 110 is adjacent to the lower substrate 102. A back light module 111 illuminates the LCD panel.

FIG. 2 is a schematic view showing orientations of the alignment layers and transmission axes of the polarizers. Referring to FIG. 2, the upper polarizer 109 and the lower polarizer 110 respectively comprise a first transmissive axis 201 and a second transmissive axis 202. The first alignment layer 106 and the second alignment layer 108 respectively comprise a first orientation 203 and a second orientation 204. In FIG. 2, the first orientation 203 and the second orientation 204 are perpendicular with each other and have a 45° included angle from the lateral side of the LCD panel. The first transmissive axis 201 and the second transmissive axis 202 are perpendicular to each other. The first orientation 203 is perpendicular to the first transmissive axis 201, while the second orientation 204 is perpendicular to the second transmissive axis 202. When there is no electric field between the common electrode 105 and the pixel electrode 107 as shown in region 120a of FIG. 1, the liquid crystal molecules are respectively aligned along the first orientation 203 and the second orientation 204 and substantially parallel to the upper and lower substrates 101 and 102. The incident light polarized by the lower polarizer 110 and optically rotated by the liquid crystal molecules can pass through the upper polarizer 109. When an electric field is applied between the common electrode 105 and the pixel electrode 107 as shown in the region 120b of FIG. 1, the liquid crystal molecules are substantially perpendicular to the upper and lower substrates 101 and 102 due to the electric field. Since the liquid crystal molecules are reoriented and cannot rotate light, the incident light polarized by the lower polarizer 110 can be blocked by the first transmissive axis 201 of the upper polarizer 109.

FIG. 3 shows a view angle diagram of a conventional twisted nematic liquid crystal display device. Since the first orientation 203 and the second orientation 204 comprise a 45° included angle therebetween, the conventional TN LCD has better viewing qualities at 45°, 135°, 225°, and 315°. In both the right-left region and the up-down region, however, the view angles are quite limited.

For display applications, viewing characteristics in both the right-left region and the up-down region are specifically more important than those in other directions. Conventional TN LCDs, however, cannot meet such requirements; hence, a wide viewing angle film incorporating a horizontal orientation of the first alignment layer and a vertical orientation of the second alignment layer is adopted to improve viewing characteristics. Gray scale inversion and color shift, however, still exist in conventional TN LCDs.

### BRIEF SUMMARY OF THE INVENTION

A detailed description is given in the following embodiments with reference to the accompanying drawings.

The invention provides a liquid crystal display. An exemplary embodiment of a twisted nematic liquid crystal display panel comprises an upper substrate, a lower substrate, a liquid crystal layer interposed between the upper and the lower substrates. A color filter and a first alignment layer are disposed on an inner surface of the upper substrate and adjacent to the liquid crystal. An array of transistors and a second alignment layer are disposed on an inner surface of the lower substrate and adjacent to the liquid crystal. An upper polarizer and a lower polarizer are respectively disposed on both sides of the liquid crystal display panel, wherein the upper polarizer is disposed on an outer side of the upper substrate and the lower polarizer is disposed on an outer surface of the lower substrate, and wherein the upper polarizer comprises a plurality of microparticles. The first alignment layer provides a first orientation and the second alignment layer provides a second orientation. The first and the second orientations are substantially perpendicular to each other and substantially parallel to lateral sides of the liquid crystal display panel.

Another exemplary embodiment of a liquid crystal display panel comprises an upper substrate, a lower substrate, and a liquid crystal layer interposed therebetween. A color filter and a first alignment layer are disposed on an inner surface of the upper substrate and adjacent to the liquid crystal. An array of transistors and a second alignment layer are disposed on an inner surface of the lower substrate and adjacent to the liquid crystal, wherein the color filter comprises a plurality of microparticles. An upper polarizer and a lower polarizer are respectively disposed on both sides of the liquid crystal display panel, wherein the upper polarizer is disposed on top of the upper substrate and the lower polarizer is disposed on bottom of the lower substrate. The first alignment layer provides a first orientation and the second alignment layer provides a second orientation. The first and the second orientations are substantially perpendicular to each other and substantially parallel with lateral sides of the liquid crystal display panel.

Another exemplary embodiment of a liquid crystal display panel comprises a color filter substrate, a thin film transistor (TFT) array substrate, and a liquid crystal layer interposed therebetween. A first alignment layer and a common electrode are disposed on an inner surface of the color filter substrate. A second alignment layer and a pixel electrode are disposed on an inner surface of the TFT array substrate. An upper polarizer is disposed on an outer surface of the of the color filter substrate. A lower polarizer is: disposed on an outer surface of the TFT array substrate. A back light module illuminating the liquid crystal display panel, wherein the first alignment layer provides a first orientation and the second alignment layer provides a second orientation, and the first and the second orientations are substantially perpendicular to each other and substantially parallel to lateral sides of the liquid crystal display panel.

### BRIEF DESCRIPTION OF THE DRAWINGS

The invention can be more fully understood by reading the subsequent detailed description and examples with references made to the accompanying drawings, wherein:

FIG. 1 is a cross section of a conventional twisted nematic liquid crystal display (TN LCD);

FIG. 2 is a schematic view showing orientations of the alignment layers and transmission axes of the polarizers;

FIG. 3 shows a view angle diagram of a conventional twisted nematic liquid crystal display device;

FIG. 4 is a cross section of a twisted nematic liquid crystal display according to an embodiment of the invention;

FIGS. 5A and 5B are schematic views showing a first transmissive axis 501 of the upper substrate, a second transmissive axis 502 of the lower substrate, a first orientation 503 of the first alignment layer, and the second orientation 504 of the second alignment layer;

FIG. 6 is a cross section of a twisted nematic liquid crystal display according to another embodiment of the invention;

FIG. 7 is a cross section of another exemplary embodiment of a twisted nematic liquid crystal display;

FIG. 8 shows a view angle diagram of a twisted nematic liquid crystal display device according to an embodiment of the invention;

FIG. 9 shows a relationship of luminance dependent from polar angles of a conventional and an exemplary embodiment of the twisted nematic liquid crystal displays; and

FIG. 10 shows a relationship of color shift dependent from viewing angles of a conventional and an exemplary embodiment of the twisted nematic liquid crystal displays.

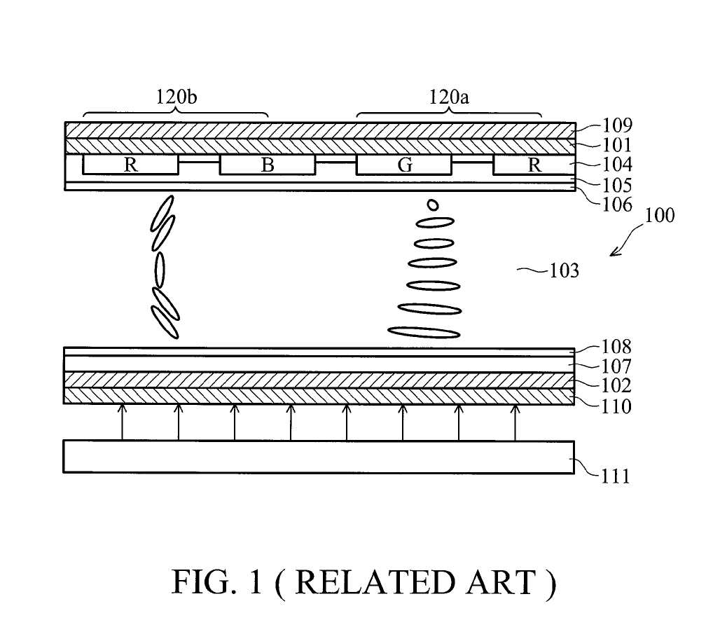

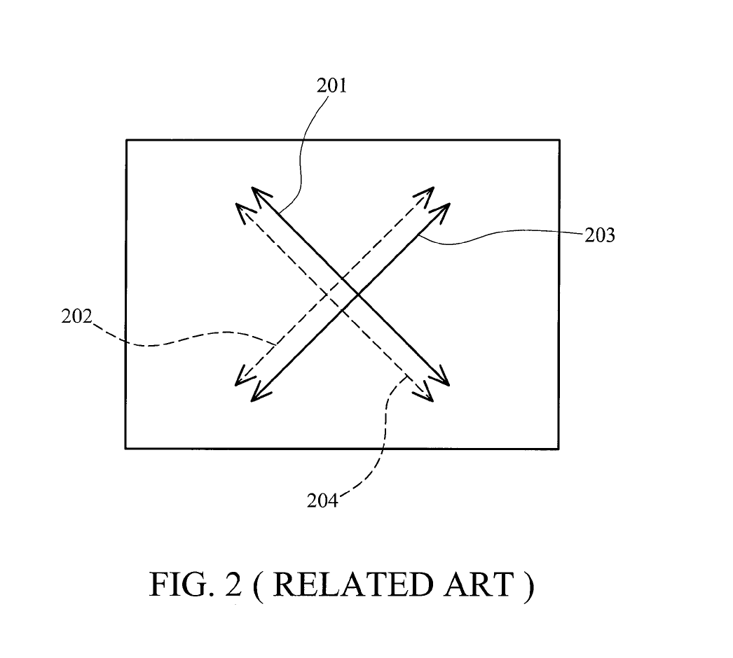

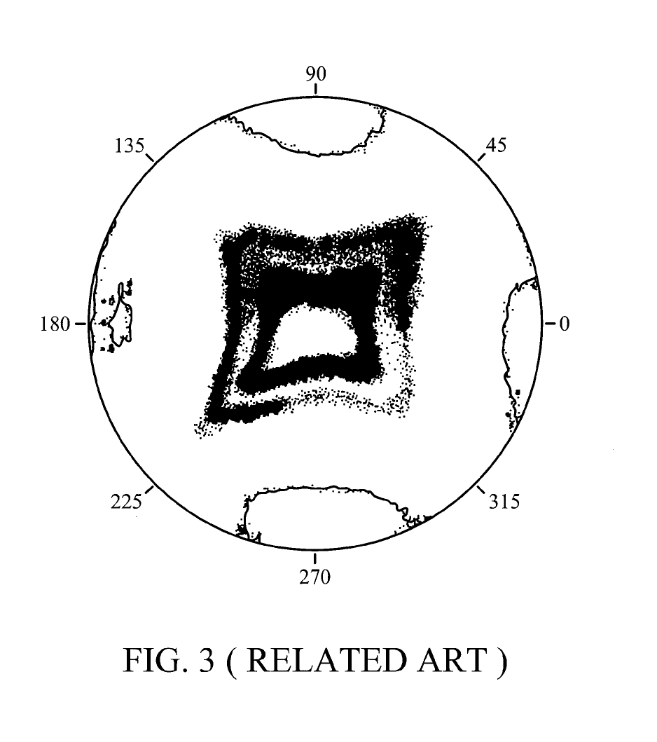

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

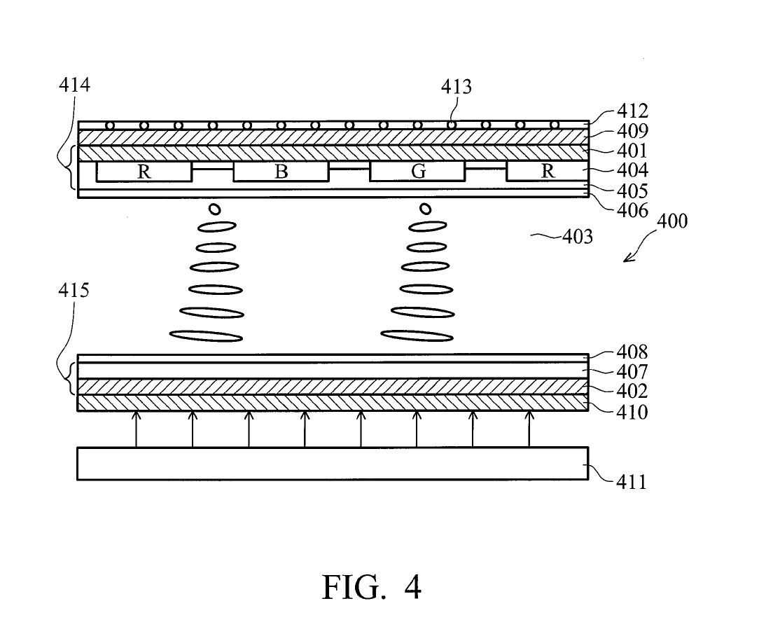

FIG. 4 is a cross section of a twisted nematic liquid crystal display according to an embodiment of the invention. In FIG. 4, a liquid crystal display 400 comprises an upper substrate 401, a lower substrate 402, and a liquid crystal layer 403 interposed between the upper substrate 401 and the lower substrate 402 to serve as an LCD panel. Both the upper and the lower substrates 401 and 402 are made of transparent materials, such as glass substrates. A color filter 404 and a common electrode 405 are disposed on the inner surface of the upper substrate 401 to serve as a color filter substrate. A first alignment layer 406 is formed on the inner surface of the upper substrate 401 and adjacent to the liquid crystal layer 403. A TFT array (not shown in FIG. 4) and a pixel electrode 407 are disposed on the inner surface of the lower substrate 402 to serve as a TFT substrate 415. A second alignment layer 408 is disposed on the inner surface of the lower substrate 402 and adjacent to the liquid crystal layer 403. The liquid crystal display 400 further comprises an upper polarizer 409 and a lower polarizer 410 respectively disposed on both sides of the LCD panel. The upper polarizer 409 is disposed above the upper substrate 401, while the lower polarizer 410 is disposed beneath the lower substrate 402. A backlight module 411 is disposed at the bottom of the LCD panel and illuminating the liquid crystal display panel.

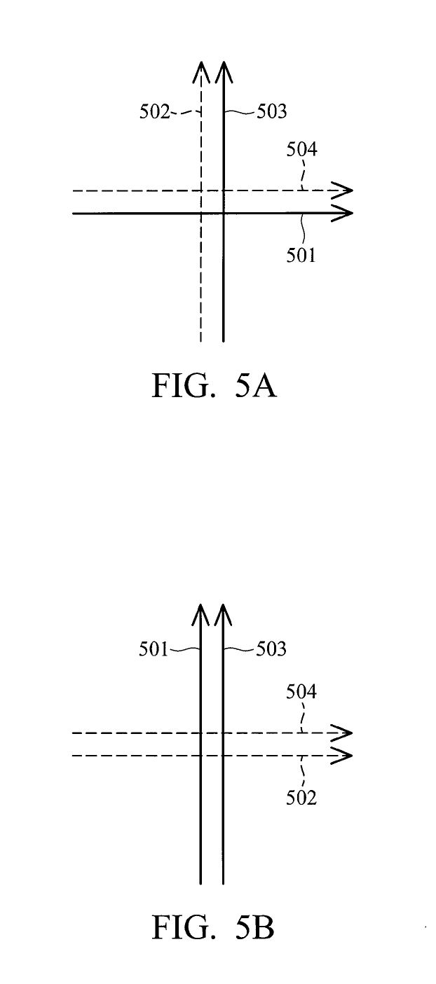

FIGS. 5A and 5B are schematic views showing a first transmissive axis 501 of the upper substrate, a second transmissive axis 502 of the lower substrate, a first orientation 503 of the first alignment layer, and the second orientation 504 of the second alignment layer. When the TN LCD is in an O-mode as shown in FIG. 5A, the first orientation 503 is vertical while the second orientation 504 is horizontal. The first transmissive axis 501 is substantially perpendicular to the first orientation 503, i.e., the first transmissive axis 501 is horizontal. The second transmissive axis 502 is substantially perpendicular to the second orientation 504, i.e., the first transmissive axis 501 is vertical. When the TN LCD is in an E-mode as shown in FIG. 5B, the first orientation 503 is vertical while the second orientation 504 is horizontal. The first transmissive axis 501 is substantially parallel to the first orientation 503, i.e., the first transmissive axis 501 is also vertical. The second transmissive axis 502 is substantially parallel to the second orientation 504, i.e., the first transmissive axis 501 is also horizontal.

According to an aspect of the invention, the upper polarizer 409 comprises a diffusive layer 412 disposed thereon and opposing the counter side of the upper substrate 401. A plurality of microparticles 413 are dispersed in the diffusive layer 412. The thickness of the upper polarizer 405 is approximately 350 μm. The thickness of the diffusive layer 412 is approximately 30 μm. The plurality of microparticles are spherical or semi-spherical or conical, or pyramidal or spheroidal, or discoidal, or circular with a diameter less than 30 mm. Since the microparticles 413 are inner diffusive, incident light passes through the lower polarizer 410, liquid crystal layer 403, and the upper polarizer 409 sequentially, and is diffused by the microparticles 413, thereby preventing gray scale inversion and color shift. Furthermore each one of the upper and lower polarizer may comprise an optically compensatory layer, and the optically compensatory layer comprises a discotic liquid crystal layer or a nematic liquid crystal layer (not shown in FIG. 4), and the discotic liquid crystal layer or the nematic liquid crystal layer is disposed on the inner surface of the upper and lower polarizer. A color liquid crystal display provided with an optical compensatory layer which gives an enlarged viewing angle and is almost free from reversion of black-and-white image or gradation.

While this embodiment has been described in conjunction with an example of a twisted nematic (TN) mode liquid crystal display, the features of this embodiment may also be applied to an optical compensated birefringence (OCB) mode, an in-plane switch (IPS) mode, or a vertical aligned (VA) mode liquid crystal display.

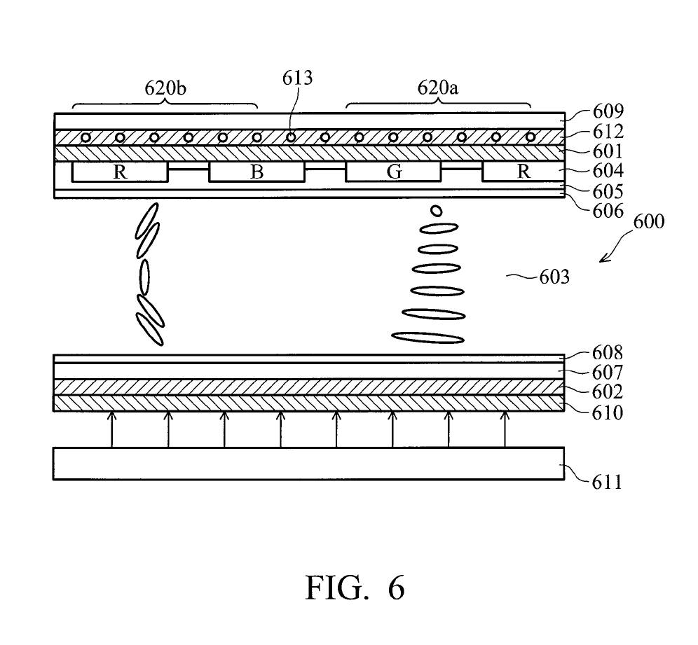

FIG. 6 is a cross section of another embodiment of a twisted nematic liquid crystal display according to the invention. In FIG. 6, a configuration of a liquid crystal display 600 is similar to that of the liquid crystal display 400, comprising an upper substrate 601, a lower substrate 602, and a liquid crystal layer 603 interposed between the upper substrate 601 and the lower substrate 602 to serve as an LCD panel. A color filter 604 and a common electrode 605 are disposed on the inner surface of the upper substrate 601 to serve as a color filter substrate. A first alignment layer 606 is formed on the inner surface of the upper substrate 601 and adjacent to the liquid crystal layer 603. A TFT array (not shown in FIG. 6) and a pixel electrode 607 are disposed on the inner surface of the lower substrate 602 to serve as a TFT substrate. A second alignment layer 608 is disposed on the inner surface of the lower substrate 602 and adjacent to the liquid crystal layer 603. The liquid crystal display 600 further comprises an upper polarizer 609 and a lower polarizer 610 respectively disposed on both sides of the LCD panel. The upper polarizer 609 is disposed above the upper substrate 601, while the lower polarizer 610 is disposed beneath the lower substrate 602. A backlight module 611 is disposed at the bottom of the LCD panel and illuminating the liquid crystal display panel. When there is no electric field between the common electrode 605 and the pixel electrode 607 as shown in the region 620a of FIG. 6, the liquid crystal molecules are substantially parallel to the upper and lower substrates 601 and 602. The incident light optically rotated by the liquid crystal molecules can pass through the upper polarizer 609. When an electric field is applied between the common electrode 605 and the pixel electrode 607 as shown in the region 620b of FIG. 6, the liquid crystal molecules are substantially perpendicular to the upper and lower substrates 601 and 602 and unable to rotate light due to the electric field. The incident light is thus blocked by the upper polarizer 609. The liquid crystal display 600 is different from the liquid crystal display 400 of FIG. 4 in that the diffusive layer 612 is interposed between the upper polarizer 609 and the upper substrate 601. Since the microparticles 613 are inner diffusive, incident light passes through the lower polarizer 610, liquid crystal layer 603, and the upper polarizer 609 sequentially, and is diffused by the microparticles 613. Furthermore each one of the upper and lower polarizer may comprise an optically compensatory layer, and the optically compensatory layer comprises a discotic liquid crystal layer or a nematic liquid crystal layer (not shown in FIG. 6), and the discotic liquid crystal layer or the nematic liquid crystal layer is disposed on the inner surface of the upper and lower polarizer. A color liquid crystal display provided with an optical compensatory layer which gives an enlarged viewing angle and is almost free from reversion of black-and-white image or gradation.

While this embodiment has been described in conjunction with an example of a twisted nematic (TN) mode liquid crystal display, the features of this embodiment may also be applied to an optical compensated birefringence (OCB) mode, an in-plane switch (IPS) mode, or a vertical aligned (VA) mode liquid crystal display.

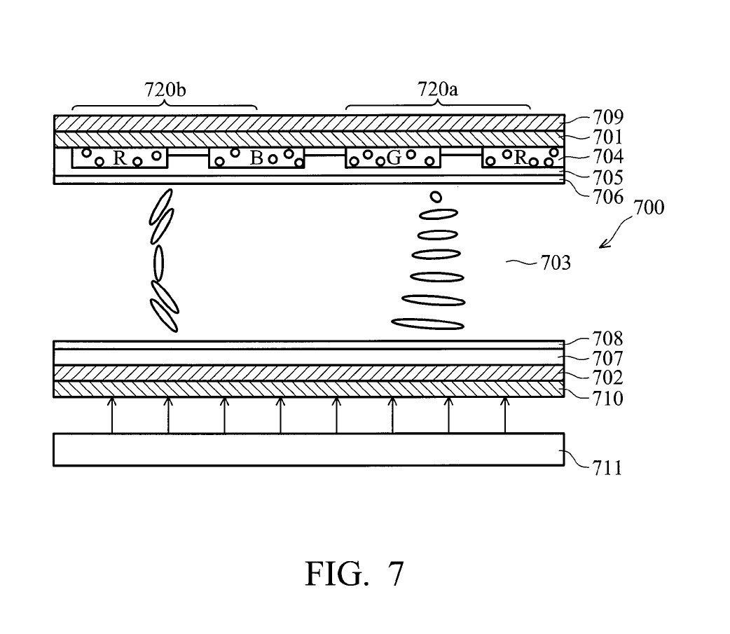

FIG. 7 is a cross section of another exemplary embodiment of a twisted nematic liquid crystal display. In FIG. 7, a liquid crystal display 700 comprises an upper substrate 701, a lower substrate 702, and a liquid crystal layer 703 interposed between the upper substrate 701 and the lower substrate 702 to serve as an LCD panel. A color filter 704 and a common electrode 705 are disposed on the inner surface of the upper substrate 701 to serve as a color filter substrate. A first alignment layer 706 is formed on the inner surface of the upper substrate 701 and adjacent to the liquid crystal layer 703. A TFT array (not shown in FIG. 7) and a pixel electrode 707 are disposed on the inner surface of the lower substrate 702 to serve as a TFT substrate. A second alignment layer 708 is disposed on the inner surface of the lower substrate 702 and adjacent to the liquid crystal layer 703. The liquid crystal display 700 further comprises an upper polarizer 709 and a lower polarizer 710 respectively disposed on both sides of the LCD panel. The upper polarizer 709 is disposed above the upper substrate 701, while the lower polarizer 710 is disposed beneath the lower substrate 702. A backlight module 711 is disposed at the bottom of the LCD panel and illuminating the liquid crystal display panel. When there is no electric field between the common electrode 705 and the pixel electrode 707 as shown in the region 720a of FIG. 7, the liquid crystal molecules are substantially parallel to the upper and lower substrates 701 and 702. Thus, the incident light optically rotated by the liquid crystal molecules can pass through the upper polarizer 709. When an electric field is applied between the common electrode 705 and the pixel electrode 707 as shown in the region 720b of FIG. 7, the liquid crystal molecules are substantially perpendicular to the upper and lower substrates 701 and 702 and unable to rotate light due to the electric field. The incident light is thus blocked by the upper polarizer 709. The liquid crystal display 700 is different from the liquid crystal displays 400 and 600 in that the upper polarizer 709 does not comprise the microparticles. Conversely, the color filter 704 comprises a plurality of circular microparticles 713. As incident light passes through the lower polarizer 710, liquid crystal layer 703, and the color filter 704 sequentially, and is diffused by the plurality of circular microparticles 713. Furthermore each one of the upper and lower polarizer may comprise an optically compensatory layer, and the optically compensatory layer comprises a discotic liquid crystal layer or a nematic liquid crystal layer (not shown in FIG. 7), and the discotic liquid crystal layer or the nematic liquid crystal layer is disposed on the inner surface of the upper and lower polarizer. A color liquid crystal display provided with an optical compensatory layer which gives an enlarged viewing angle and is almost free from reversion of black-and-white image or gradation.

While this embodiment has been described in conjunction with an example of a twisted nematic (TN) mode liquid crystal display, the features of this embodiment may also be applied to an optical compensated birefringence (OCB) mode, an in-plane switch (IPS) mode, or a vertical aligned (VA) mode liquid crystal display.

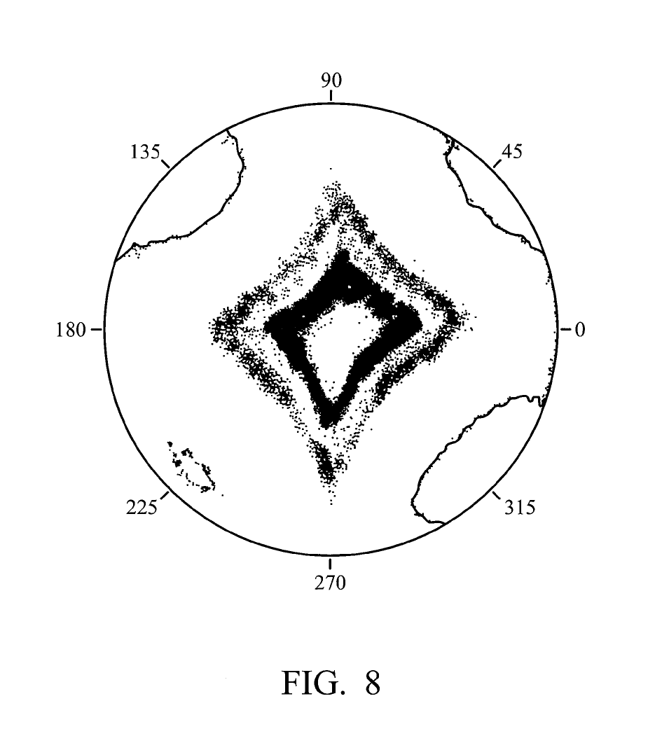

FIG. 8 shows a view angle diagram of a twisted nematic liquid crystal display device according to an embodiment of the invention. Since the first orientation and the second orientation are respectively horizontal and vertical, the TN LCD has better viewing qualities at 0°, 90°, 180°, and 270°. In both the right-left region and the up-down region the view angle is widened.

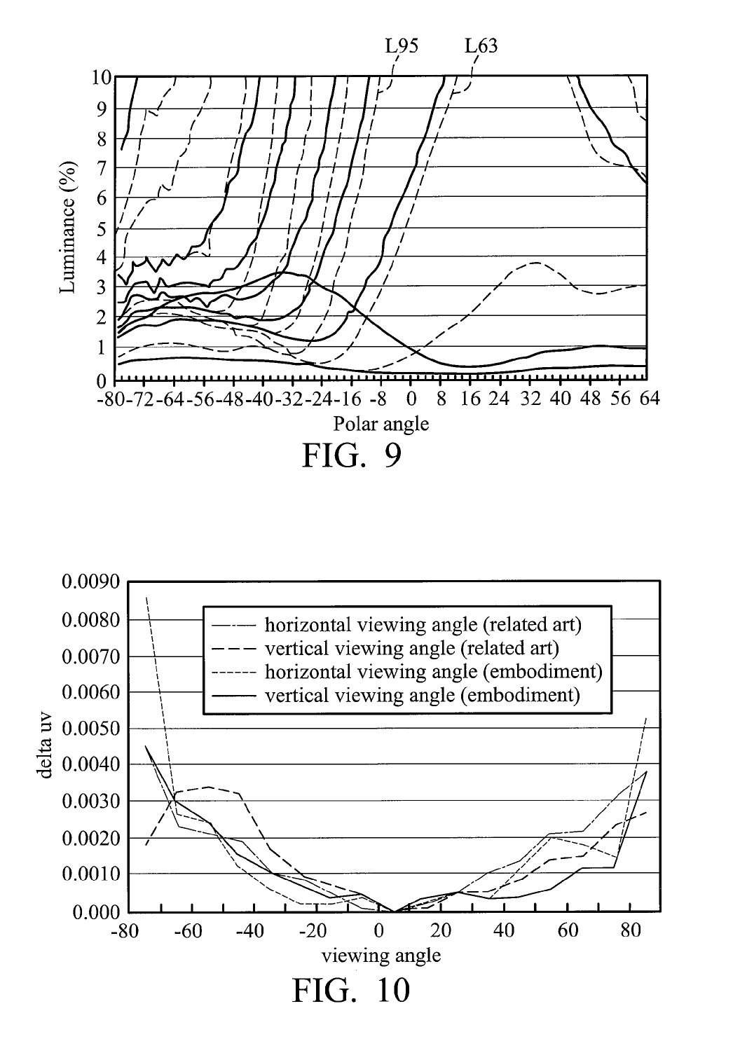

FIGS. 9 and 10 respectively show comparisons of optical characteristics between a conventional and an exemplary embodiment of the twisted nematic liquid crystal displays. Both the conventional and the exemplary embodiment of the twisted nematic liquid crystal displays comprise the same orientations of the first and the second alignment layers, i.e., vertical and horizontal orientations. The conventional TN LCD makes use of a wide viewing angle layer, while the exemplary embodiment the TN LCD makes use of an inner diffusive layer. FIG. 9 shows a relationship of luminance dependent from polar angles of a conventional and an exemplary embodiment of the twisted nematic liquid crystal displays. In FIG. 9, the brightness of a high gray scale L95 of the conventional TN LCD is greater that of a low gray scale L65 of the conventional TN LCD. At a viewing angle less than 32°, the brightness of a low gray scale L65 is greater that of a high gray scale L95, thus the conventional TN LCD exhibits gray scale inversion. Conversely, the exemplary embodiment of the TN LCD does not exhibit gray scale inversion in any range of viewing angles.

FIG. 10 shows a relationship of color shift dependent from viewing angles of a conventional and an exemplary embodiment of the twisted nematic liquid crystal displays. In FIG. 10, although the color shift increases as the viewing angle increases in both the conventional and the exemplary embodiments of the twisted nematic liquid crystal displays, the color shift of the exemplary embodiment of the twisted nematic liquid crystal display is ameliorated in comparison with the related art.

The invention is advantageous in that a TN LCD with both horizontal and vertical orientations provides observers better viewing qualities at 0°, 90°, 180°, and 270° and satisfies requirements for LCD markets. The gray inversion and color shift are eliminated using a diffusive layer on an upper polarizer or an inner diffusive layer comprising a color filter and a plurality of microparticles to diffuse backlight passing through the lower polarizer and the liquid crystal layer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display, comprising:
a liquid crystal display panel comprising an upper substrate, a lower substrate, a liquid crystal layer interposed between the upper and the lower substrates, a color filter and a first alignment layer disposed on an inner surface of the upper substrate and adjacent to the liquid crystal layer, an array of transistors and a second alignment layer disposed on an inner surface of the lower substrate and adjacent to the liquid crystal layer; and
an upper polarizer and a lower polarizer respectively disposed on both sides of the liquid crystal display panel, wherein the upper polarizer is disposed on an outer side of the upper substrate and the lower polarizer is disposed on an outer surface of the lower substrate, and wherein the upper polarizer comprises a plurality of microparticles;
wherein the first alignment layer provides a first orientation and the second alignment layer provides a second orientation, and wherein the first and the second orientations are substantially perpendicular or parallel to each other and substantially parallel or perpendicular to lateral sides of the liquid crystal display panel.

2. The liquid crystal display as claimed in claim 1, wherein the upper polarizer comprises a diffusive layer, and wherein the plurality of microparticles are dispersed in the diffusive layer.

3. The liquid crystal display as claimed in claim 2, wherein the diffusive layer is disposed on an outer surface of the upper polarizer.

4. The liquid crystal display as claimed in claim 2, wherein the diffusive layer is disposed between the upper polarizer and the upper substrate.

5. The liquid crystal display as claimed in claim 1, wherein each one of the upper and lower polarizers comprises a discotic liquid crystal layer.

6. The liquid crystal display as claimed in claim 1, wherein each one of the upper and lower polarizers comprises a nematic liquid crystal layer.

7. The liquid crystal display as claimed in claim 1, further comprising a signal driving module and a back light module illuminating the liquid crystal display panel.

8. The liquid crystal display as claimed in claim 1, further comprising a common electrode disposed on the inner surface of the upper substrate, and a pixel electrode disposed on the inner surface of the lower substrate.

9. The liquid crystal display as claimed in claim 8, wherein when an electric field is generated between the pixel electrode and the common electrode, the plurality of microparticles diffuse light from the back light module.

10. The liquid crystal display as claimed in claim 1, further comprising a plurality of common electrodes disposed on the inner surface of the lower substrate, and a plurality of pixel electrodes disposed on the inner surface of the lower substrate.

11. The liquid crystal display as claimed in claim 1, wherein the plurality of microparticles are spherical or semi-spherical or conical, or pyramidal or spheroidal, or discoidal, or circular with a diameter less than 30 μm.

12. The liquid crystal display as claimed in claim 1, wherein the upper polarizer comprises a first transmissive axis substantially perpendicular to the first orientation, and the lower polarizer comprises a second transmissive axis substantially perpendicular to the second orientation.

13. The liquid crystal display as claimed in claim 1, wherein the upper polarizer comprises a first transmissive axis substantially parallel to the first orientation, and the lower polarizer comprises a second transmissive axis substantially parallel to the second orientation.

14. The liquid crystal display as claimed in claim 1, wherein the liquid crystal layer is a twist-oriented nematic liquid crystal layer, wherein the twist angle varies within the range of 0 to 100 degrees.

15. A liquid crystal display, comprising:
a liquid crystal display panel comprising an upper substrate, a lower substrate, a liquid crystal layer interposed between the upper and the lower substrates, a color filter and a first alignment layer disposed on an inner surface of the upper substrate and adjacent to the liquid crystal, an array of transistors and a second alignment layer disposed on an inner surface of the lower substrate and adjacent to the liquid crystal, wherein the color filter comprises a plurality of microparticles; and
an upper polarizer and a lower polarizer respectively disposed on both sides the liquid crystal display panel, wherein the upper polarizer is disposed on the top of the upper substrate and the lower polarizer is disposed on the bottom of the lower substrate;
wherein the first alignment layer provides a first orientation and the second alignment layer provides a second orientation, and wherein the first and the second orientations are substantially perpendicular or parallel to each other and substantially parallel with lateral sides of the liquid crystal display panel.

16. The liquid crystal display as claimed in claim 15, wherein each one of the upper and lower polarizers comprises a discotic liquid crystal layer.

17. The liquid crystal display as claimed in claim 15, wherein each one of the upper and lower polarizers comprises a nematic liquid crystal layer.

18. The liquid crystal display as claimed in claim 15, further comprising a signal driving module and a back light module illuminating the liquid crystal display panel.

19. The liquid crystal display as claimed in claim 15, further comprising a common electrode disposed on the inner surface of the upper substrate, and a pixel electrode disposed on the inner surface of the lower substrate.

20. The liquid crystal display as claimed in claim 19, wherein when an electric field is generated between the pixel electrode and the common electrode, the plurality of microparticles diffuse light from the back light module.

21. The liquid crystal display as claimed in claim 15, further comprising a plurality of common electrodes disposed on the inner surface of the lower substrate, and a plurality of pixel electrodes disposed on the inner surface of the lower substrate.

22. The liquid crystal display as claimed in claim 15, wherein the plurality of microparticles are spherical or semi-spherical or conical, or pyramidal or spheroidal, or discoidal, or circular with a diameter less than 30 μm.

23. The liquid crystal display as claimed in claim 15, wherein the upper polarizer comprises a first transmissive axis substantially perpendicular to the first orientation, and the lower polarizer comprises a second transmissive axis substantially perpendicular to the second orientation.

24. The liquid crystal display as claimed in claim 15, wherein the upper polarizer comprises a first transmissive axis substantially parallel to the first orientation, and the lower polarizer comprises a second transmissive axis substantially parallel to the second orientation.

25. The liquid crystal display as claimed in claim 14, wherein the liquid crystal layer is a twist-oriented nematic liquid crystal layer, wherein the twist angle varies within the range of 0 to 100 degrees.

26. A liquid crystal display, comprising:
a liquid crystal display panel comprising an upper substrate, a lower substrate, a liquid crystal layer interposed between the upper and the lower substrates, a color filter and a first alignment layer disposed on an inner surface of the upper substrate and adjacent to the liquid crystal layer, an array of transistors and a second alignment layer disposed on an inner surface of the lower substrate and adjacent to the liquid crystal layer; and
an upper polarizer and a lower polarizer respectively disposed on both sides of the liquid crystal display panel, wherein the upper polarizer is disposed on an outer side of the upper substrate and the lower polarizer is disposed on an outer surface of the lower substrate, and wherein a plurality of microparticles is disposed in the upper polarizer or color filter;
wherein said first and second alignment layers for aligning liquid crystal molecules being substantially perpendicular to the surface of said alignment layers while no voltage is applied.

27. The liquid crystal display as claimed in claim 26, wherein the upper polarizer comprises a diffusive layer, and wherein the plurality of microparticles are dispersed in the diffusive layer.

28. The liquid crystal display as claimed in claim 27, wherein the diffusive layer is disposed on an outer surface of the upper polarizer.

29. The liquid crystal display as claimed in claim 27, wherein the diffusive layer is disposed between the upper polarizer and the upper substrate.

30. The liquid crystal display as claimed in claim 26, wherein the plurality of microparticles are spherical or semi-spherical or conical, or pyramidal or spheroidal, or discoidal, or circular with a diameter less than 30 μm.

31. The liquid crystal display as claimed in claim 26, wherein each one of the upper and lower polarizers comprises a discotic liquid crystal layer.

32. The liquid crystal display as claimed in claim 26, wherein each one of the upper and lower polarizers comprises a nematic liquid crystal layer.

33. The liquid crystal display as claimed in claim 26, further comprising a signal driving module and a back light module illuminating the liquid crystal display panel.

34. The liquid crystal display as claimed in claim 26, further comprising a common electrode disposed on the inner surface of the upper substrate, and a pixel electrode disposed on the inner surface of the lower substrate.
